(19) United States
(12) Patent Application Publication
(10) Pub. No.: US 2006/0063888 A1
(43) Pub. Date: Mar. 23, 2006

(54) Trivalent cation-neutralized ionomers and foams thereof

(76) Inventor: David M. Dean, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/232,049

(22) Filed: Sep. 21, 2005

Related U.S. Application Data
(60) Provisional application No. 60/611,770, filed on Sep. 21, 2004.

(51) Int. Cl. C08L 51/04; B29C 44/34

(52) U.S. Cl. 525/71; 521/142

(57) ABSTRACT

Provided are ionomer compositions neutralized with trivalent cations. The melt strength and melt viscosity are higher, and the sensitivity of melt viscosity to temperature is lower, compared to ionomer compositions that contain the same base resin and are neutralized with monovalent or divalent cations only. The compositions are suitable for preparing substantially open cell foams used in multilayer structures and articles such as diapers, adult incontinence pads and sanitary napkins.

### CROSS-REFERENCE TO RELATED APPLICATION

This application claims priority under 35 U.S.C. § 119 to U.S. Provisional Application No. 60/611,770, filed on Sep. 21, 2004, which is incorporated herein by reference in its entirety.

### FIELD OF THE INVENTION

This invention relates to trivalent cation-neutralized ionomers with melt strength and viscosity properties suitable for preparing extruded open cell foams.

### BACKGROUND OF THE INVENTION

One or more patents and publications are cited in this description in order to more fully describe the state of the art to which this invention pertains. The entire disclosure of each of these patents and publications is incorporated by reference herein.

Open cell polymeric foams have generated considerable interest for commercial use in absorbent articles such as disposable diapers, adult incontinence pads and briefs, and sanitary napkins. For example, U.S. Pat. Nos. 5,650,222, 5,741,581 and 5,744,506 describe low density absorbent foams made by polymerizing high internal phase emulsions where the volume to weight ratio of the water phase to the oil phase is in the range of from about 55:1 to about 100:1. Open cell foams based on polyolefins are particularly useful in these applications because of their outstanding chemical resistance and recyclability.

Polyolefin open cell foams are often lightly crosslinked in order to control and stabilize the size of the foam cells. Foams can be crosslinked by several methods, including, for example, irradiation and free-radical catalysis, such as by peroxides lonomers, which are copolymers having ionizable comonomers that are at least partially neutralized (ionized) to yield carboxylate salts, are also useful as components of open cell foams lonomers based on ethylene-acid copolymers are typically prepared by copolymerization of ethylene with an unsaturated carboxylic acid, followed by neutralization of some portion of the acid groups. The ionized groups can act as meltable crosslinks. For example, U.S. Pat. No. 4,102,829 describes low density extruded foams prepared from a mixture of from about 5 to 65% polyolefin and from about 35 to 95% ionomer, the ionomer being a zinc salt.

U.S. Pat. No.4,091,136 describes a fine closed cell foam produced by extrusion in rod form of a foamable mixture of polyolefin and a foaming agent together with an ethylene/methacrylic acid copolymer based ionomer resin.

In U.S. Pat. No. 4,102,829 there is described a foamed thermoplastic mixture of ionomers and polyolefin polymer produced by extruding the mix together with a volatile blowing agent at elevated temperature and pressure. The foams are said to have a good balance of properties, and are indicated to be useful as insulation covering on pipes for air conditioning.

Japanese Laid Open Patent Application H10-279724/1998 describes a foam made from 0 to 50 parts by weight of polyolefin resin and 100 to 50 parts of an ionomer resin. However, when foam extrusion of such a mixture is carried out to prepare an open cell foam, the extrusion pressure is high, leading to severe heat generation at the die. This makes it very difficult to obtain good open cell extruded foams have a high expansion ratio and high thickness. In addition, stable manufacture is difficult because the foaming temperature must be regulated within a narrow range during extrusion foaming in order to obtain open cell extruded foam.

PCT International Publication No. WO 02/27905 teaches that ionomer present in a polyethylene resin at a level of from about 1 to about 40% by weight of the resin produces superior continuously extruded foam sheet products that approach the pore size and resiliency of foams prepared from chemical blowing agents.

PCT International Publication No. WO 02/18482 describes an extruded polyolefin open cell foam, which exhibits uniform physical properties, high expansion ratio and uniform cell diameter. The base resin is principally composed of a mixed polymer consisting of 4.5 to 75 parts by weight of component A consisting of an ethylene ionomer resin, 0.5 to 30 parts by weight of component B consisting of a polyolefin resin having a melting point exceeding 120° C., and 20 to 95 parts by weight of component C consisting of one or two or more polymers selected from the group consisting of ethylene-propylene rubbers, styrene elastomers, and polyethylene resins having melting points of 120° C. or lower (where component A+component B+component C=100 parts by weight).

Japanese Patent Publication No. 56-55442 describes a resin composition comprising a copolymer of ethylene and α,β-ethylenically unsaturated carboxylic acid and optionally an α,β-unsaturated ester, partially or completely ionically crosslinked by ions, and a polyamide resin having a melting point of not more than 160° C. Ten percent or more of the α,β-unsaturated carboxylic acid component is described to be neutralized by Na⁺, Mg⁺², Zn⁺², Al⁺³ and the like. The examples describe only ionomers neutralized with magnesium, zinc and sodium ions.

U.S. Pat. No. 4,766,174 describes melt processible blends of aluminum ionomers of ethylene/α,β-ethylenically unsaturated carboxylic acid copolymers and thermoplastic resins or elastomers. From about 1 to about 100% of the carboxylic acid groups of the ethylene copolymer are neutralized with aluminum ions.

The ionomers used in the art for preparation of open cell foams typically contain divalent ions such as calcium or zinc. As indicated in the documents cited above, it has been very difficult to manufacture an open cell extruded foam exhibiting a high expansion ratio and a high open cell foaming ratio, in a stable process using calcium or zinc ionomers alone, or using blends of these ionomers and polyolefin resins. Consequently, there is a need in the art for ionomer-based open cell foam compositions with improved rheological properties, specifically, high melt strength, high viscosity and minimal sensitivity of viscosity to temperature, in order to achieve optimum processibility and extruded foam properties.

### SUMMARY OF THE INVENTION

This invention is directed to an ionomer composition comprising at least one direct or graft copolymer of ethylene, α,β-ethylenically unsaturated carboxylic acid having from 3 to 8 carbon atoms, and softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms; wherein the unsaturated carboxylic acid content is from about 1 to about 25 weight percent, the softening comonomer content is from 0 to about 60 weight percent; the remainder being ethylene, such that the ethylene content is greater than about 30 weight percent; further wherein the acid groups derived from the α,β-ethylenically unsaturated carboxylic acid are about 3 to about 50% neutralized with trivalent cations and from 0 to about 70% neutralized with mono- or divalent cations. The ionomer composition may be a foamed composition.

This invention is also directed to a multilayer structure comprising at least one layer of the foamed composition in contact with at least one layer of superabsorbent polymer.

Also provided are an article comprising the ionomer composition of the invention, an article comprising the multilayer structure of the invention, and a process for preparing the ionomer composition of the invention.

### DETAILED DESCRIPTION OF THE INVENTION

The following definitions apply to the terms as used throughout this specification, unless otherwise limited in specific instances.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately described. Where a range of numerical values is recited herein, unless otherwise stated, the range is intended to include the endpoints thereof, and all real numbers within the range. When a component is indicated as present in a range starting from 0, such component is an optional component (i.e., it may or may not be present).

The term “(meth)acrylic”, as used herein, alone or in combined form, such as “(meth)acrylate”, refers to acrylic and/or methacrylic, for example, acrylic acid and/or methacrylic acid, or alkyl acrylate and/or alkyl methacrylate.

The terms “finite amount” and “finite value”, as used herein, refer to an amount that is not equal to zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

As indicated above, the ionomer compositions of the invention comprise at least one direct or graft copolymer of ethylene, an α,β-ethylenically unsaturated carboxylic acid, and an optional softening comonomer selected from the group consisting of vinyl esters, alkyl vinyl ethers, and alkyl(meth)acrylates. These copolymers and methods for their preparation have been described in, for example, U.S. Pat. Nos. 3,264,272 and 4,766,174.

The α,β-unsaturated carboxylic acid of the ionomer contains from about 3 to about 8 carbon atoms. Preferably the α,β-ethylenically unsaturated carboxylic acid is selected from the group consisting of (meth)acrylic acid, maleic acid, fumaric acid, itaconic acid, and half esters of maleic, fumaric and itaconic acids. More preferably the α,β-unsaturated carboxylic acid is (meth)acrylic acid, and still more preferably the acid is methacrylic acid.

The optional softening comonomer, when present, is selected from vinyl esters, alkyl vinyl ethers, and alkyl(meth)acrylates. Accordingly, suitable softening monomers are, for example, vinyl acetate, butyl vinyl ether, methyl vinyl ether, methyl(meth)acrylate, ethyl(meth)acrylate, and butyl(meth)acrylate. Preferably the softening comonomer is alkyl(meth)acrylate or alkyl vinyl ether, and more preferably the softening comonomer is butyl acrylate.

The ethylene content of the ethylene/acid copolymer preferably is greater than about 50 weight percent, and more preferably greater than about 60 weight percent.

The ethylene/acid copolymer preferably contains from 0 to about 40 weight percent of softening comonomer. More preferably the copolymer contains from about 5 to about 15 weight percent of unsaturated carboxylic acid and from 0 to about 30 weight percent of softening monomer; the remainder being ethylene, such that the ethylene content is greater than about 60 weight percent.

In the ionomers of the present invention, from about 3 to about 50% of the carboxylic acid groups are neutralized with trivalent cations. In the context of this disclosure, the percent neutralization data are presented using the assumption that each cation will react with the maximum number of carboxylic acid groups calculated from its ionic charge. That is, it is assumed, for example, that Al⁺³ will react with three carboxylic acid groups, that Mg⁺² and Zn⁺² will react with two, and that Na⁺ will react with one.

The trivalent cation can be any positively charged ion capable of reacting with three carboxylic acid groups. Preferably the trivalent cations are selected from the group consisting of trivalent lanthanide metal cations, aluminum cation, chromium cation, and iron cation. The most preferred trivalent cation is aluminum cation. The source of trivalent cation may be any convenient derivative such as carboxylates, alkoxides, chelated compounds and hydroxides. In the case of aluminum cation the preferred sources are aluminum acetate, aluminum isopropoxide and aluminum acetylacetonate.

It is preferred that from about 20% to about 80% of the ionomer carboxylic acid groups are neutralized by trivalent cations (from about 3 to about 50%), and, if present, monovalent and/or divalent cations. Generally the reaction of the ion sources with the carboxylic acid containing polymers is carried out by melt blending at temperatures in the range from about 150° to about 300° C.

In addition to neutralization with trivalent cations, some of the carboxylic acid groups of the ionomers may optionally be neutralized with mono- or divalent cations. Preferably monovalent cations, if present, are selected from the group consisting of sodium, potassium, and lithium, and divalent cations, if present, are selected from the group consisting of zinc, magnesium and calcium. More preferably the monovalent cation will be sodium, and the divalent cation will be zinc. Mono- and divalent ion sources are typically formates, acetates, hydroxides, nitrates, carbonates and bicarbonates.

Preferably, a finite amount up to about 70% of the carboxylic acid groups are neutralized with mono- or divalent cations. More preferably, from about 1% to a maximum of about 70% of those acid groups present in the copolymer are neutralized with mono- or divalent cations. A more preferable maximum is about 60% and most preferable maximum about 55%.

The trivalent cation containing ionomers of the invention exhibit surprising properties. For example, the melt strength and melt viscosity are higher, and the sensitivity of melt viscosity to temperature is lower, compared to ionomer compositions that contain the same base resin and are neutralized with monovalent or divalent cations only. Moreover, the aluminum-containing ionomers are characterized by having a flex modulus of less than about 15,000 psi in the solid, non-foamed state. In addition, these same improved melt strength and melt viscosity properties are expected when the aluminum-containing ionomers are blended with other thermoplastic polymers. That is, the melt strength and melt viscosity are expected to be higher than the same blends based on the same ionomer copolymer but neutralized only with mono- or divalent cations and the sensitivity of melt viscosity to temperature lower than the same blends based on the same ionomer copolymer but neutralized only with mono- or divalent cations.

Blends of thermoplastic polymers with the ionomer compositions of the invention are particularly useful in preparing extruded foams. Preferred thermoplastic polymers for blending with the ionomers of the invention are polyethylene, polypropylene and copolymers thereof, polybutene-1, poly(4-methylpentene-1), polystyrene and copolymers thereof. A more preferred blending polymer is polyethylene, and a still more preferred blending polymer is linear, low-density polyethylene.

The polymer blend containing at least one thermoplastic polymer may further comprise at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber (EPDM).

Preferred blends comprise preferred ionomer compositions described above.

Preferably the amount of thermoplastic polymer used in blends with the trivalent cation-containing ionomer will be from 0 to about 85 weight percent, more preferably from 0 to about 75 weight percent, and still more preferably from about 0 to about 65 weight percent.

Blends of trivalent cation-containing ionomer and thermoplastic polymer(s) can be prepared by mixing the ionomer and polymer(s) at a temperature in the range from about 150° C. to about 300° C., preferably from about 180° C. to about 295° C., and most preferably from about 200° C. to about 290° C. Alternatively, the thermoplastic polymer may be blended with the ethylene/α,β-ethylenically unsaturated carboxylic acid copolymer, and then the resulting blend can be treated with the neutralizing ion sources. In yet another alternative procedure the mixing of the polymers and neutralization may be carried out simultaneously.

Without being limited to any particular theory, it is believed that the surprisingly improved rheological properties of the at least partially neutralized trivalent cation containing ionomers, particularly aluminum-containing ionomers, lead to substantially improved processing conditions for preparation of extruded foams when compared to neutralized ionomers containing only mono- and divalent neutralizing ions.

The foamed compositions of the present invention can be obtained by taking the base composition(s) discussed above, e.g., at least partially neutralized ionomer or at least partially neutralized ionomer and thermoplastic polymer, together with any additives used to control foam properties, supplying these to an extruder, subjecting these materials to melting under heating and kneading, then supplying a foaming agent and forming a foaming molten resin mixture, then regulating processing parameters such as the extrusion temperature, pressure inside the extrusion die, discharge volume, etc., and extruding the mixture from the die into a low pressure region and causing foaming. For mixing the components methods known in the art can be utilized, such as dry blending the mixture components or using a screw feeder or the like to introduce each of the mixture components from a raw material supply port and mixing them together inside the extruder. By selecting the die attached to the tip of the extruder according to the shape of the foam desired, extruded foam of various shapes can be manufactured.

The foaming agents used in the manufacture of the foams of the present invention can be either physical foaming agents or decomposing-type chemical foaming agents, but the use of physical foaming agents is preferred in order to obtain extruded open cell foam. For physical foaming agents, low boiling hydrocarbons such as propane, n-butane, isobutane, n-pentane, isopentane, n-hexane, cyclohexane, etc., chlorinated hydrocarbons such as methyl chloride and ethyl chloride, fluorocarbons such as 1,1,1,2-tetrafluoroethane and 1,1-difluoroethane, and other materials such as carbon dioxide, nitrogen and water may be utilized. For decomposing-type foaming agents, azodicarbonamide and the like may be employed. The foaming agents can be used in mixtures of two or more, and a decomposing type may be used together with a physical type and thus serve to regulate cell diameter.

The extrusion temperature preferably will be within the range from about 100° C. to about 250° C. and more preferably from about 150° C. to about 230° C. When the extrusion temperature is below about 100° C., the elastic forces of the polymeric components will be too strong, and thus it may not be possible to obtain a foam with a high expansion ratio. When the temperature exceeds about 250° C., on the other hand, the foam may tend to shrink or giant cells may be produced. However, in the case of the present invention, relative insensitivity of the viscosity to temperature on the part of the trivalent cation neutralized ionomers will minimize the effects of temperature on the foaming process and properties.

The foams of the invention may be open or closed cell foams or mixtures thereof, with densities of from about 10 to about 200 kg/m³, more preferably from about 20 to about 150 kg/m³. Preferably about 50% of the foam cells in a foamed composition are open cells. The term “open cell” in this context means that an individual cell of the foam is incompletely sealed, providing unobstructed communication with at least one adjoining cell. Stated alternatively, the cells in open celled foam structures have at least one intercellular opening or “window” that is large enough to permit fluid transfer from one cell to another within the foam structure. Preferably, the foams of the invention comprise a substantial proportion of open cells.

Substantially open cell foams are desirable in articles used for disposable product applications such as diapers, adult incontinence pads, sanitary napkins and the like. When used in such articles, open cell foams often are used in conjunction with superabsorbent polymer that is present in such products in contact with the open cell foam. The superabsorbent polymer may be present at the surface of the cell walls of the foam.

Accordingly, this invention also provides a multilayer structure comprising at least one layer of the foam composition in contact with at least one layer of superabsorbent polymer. Preferably, in the foam composition in the multilayer structure at least 50% of the foam cells are open cells. The multilayer structure may comprise one or more layers of superabsorbent polymer between layers of the extruded open cell foam. Examples of superabsorbent polymer are those based on sodium salts of poly(acrylic acid), such as AQUAKEEP J550 available from the Sumitomo Seiko Chemicals Co., Ltd., of Osaka, Japan. Preferred multilayer structures comprise preferred compositions described above.

This invention also provides articles comprising the compositions described above, particularly foamed compositions. These articles include disposable product applications such as diapers, adult incontinence pads, sanitary napkins and the like. Preferred articles comprise preferred compositions described above. In preferred embodiments, the ionomer composition is a foamed composition having a density of from about 10 to about 200 kg/m³. Preferably, in the foam composition, at least 50% of the foam cells are open cells.

Of note are articles comprising a multilayer structure comprising at least one layer of the foam composition in contact with at least one layer of superabsorbent polymer. The multilayer structure in such articles may comprise a layer of superabsorbent polymer between two layers of the extruded open cell foam.

The following examples are presented to more fully demonstrate and further illustrate various aspects and features of the present invention. As such, the showings are intended to further illustrate the differences and advantages of the present invention but are not meant to be limiting in any way.

### EXAMPLES

In the following examples lonomer A was a copolymer of ethylene, 9 weight % methacrylic acid and 23.5 weight % n-butyl acrylate with 51% of the methacrylic acid groups neutralized with Zn⁺² cations having a measured melt index (190° C./2.16 kg weight) of 0.6. lonomer B was a copolymer of ethylene and 10.5 weight % methacrylic acid with 68% of the methacrylic acid groups neutralized with Zn⁺² cations having a measured melt index (190° C./2.16 kg weight) of 1.1. The ionomers were prepared by procedures described in U.S. Pat. No.3,264,272. Aluminum cations were introduced into the ionomers as aluminum acetylacetonate. The calculated values in the tables below for percent acid of the ionomer neutralized by Al⁺³ assume that all of the aluminum ions form trivalent salts with the ionomer carboxylic acid groups.

The formulations shown in Table 1 were compounded using a 30 mm BUSS-KNEADER extruder. Extruder zones from the feed to the die were set at temperatures of 130° C., 140° C., 145° C., and 150° C. respectively. The temperatures of the cross-head and die were set at 165° C. The materials were compounded at 5 pounds/hour and 150 RPM. The components were premixed by tumble mixing ingredients in a polyethylene bag and were then fed to the BUSS-KNEADER extruder.

Temperatures of the melt streams exiting the extruder were measured with a handheld thermocouple and were in the range of from 180 to 200° C. The calculated percent of methacrylic acid that was neutralized by the aluminum cations is given in Table 1.

TABLE 1

| | Comparative | Comparative | | | |
|---|---|---|---|---|---|
| Material | Example 1 | Example 2 | Example 3 | Example 4 | Example 5 |
| Ionomer A (weight %) | 100 | 0 | 99.32 | 98.64 | 97.99 |
| Ionomer B (weight %) | 0 | 100 | 0.00 | 0.00 | 0.00 |
| Aluminum | 0 | 0 | 0.68 | 1.36 | 2.01 |
| Acetylacetonate | | | | | |
| (weight %) | | | | | |
| Calculated % Acid of | — | — | 6% | 12% | 18% |
| Ionomer | | | | | |
| Neutralized by Al⁺³ | | | | | |

Viscosity data were acquired using a KAYENESS GALAXY 5 CAPILLARY RHEOMETER. The cylindrical capillary die had dimensions of 30 mm long with a diameter of 1 mm (L/D=30). A pre-heat dwell time of 5 minutes was used before beginning the viscosity test. The apparent viscosities for the samples at various temperatures were obtained after drying the materials at 50° C. for 18 hours, per ASTM D3835, and are reported in Tables 2 and 3. At higher shear rates, certain compounds overpressured the rheometer and viscosity data could not be acquired. These points are noted as ND (No Data) in the following Tables.

TABLE 2
Apparent Viscosity (Pascal seconds) as
Function of Shear Rate at 220° C.

| Apparent | | | | | |
|---|---|---|---|---|---|
| Shear Rate | Comp. | Comp. | | | |
| (s⁻¹) | Ex. 1 | Ex. 2 | Ex. 3 | Ex. 4 | Ex. 5 |
| 316.20 | 398.4 | 518 | 769.7 | 1020.6 | 1249 |
| 7.3 | 3109 | 2869.6 | 3937.8 | 6361 | 7429.2 |
| 12.2 | 2478 | 2534.8 | 3759.2 | 4438.4 | 5366.2 |
| 24.3 | 1492 | 1587.9 | 2635.3 | 3328.8 | 4022.3 |
| 36.5 | 1043 | 1307.3 | 2263.8 | 2796.3 | 3395.7 |
| 73.0 | 757.3 | 964.5 | 2059.8 | 2027.9 | 2448.8 |
| 97.3 | 666 | 847.7 | 1480.3 | 1825.8 | 2249.1 |
| 145.9 | 562 | 713.4 | 1197.3 | 1512.9 | 1878 |
| 316.2 | 396.2 | 509.2 | 825.6 | 1057.4 | 1307.5 |
| 681.0 | 274.7 | 346.7 | 557.9 | 716.4 | 867.2 |
| 1447.2 | 184.6 | 230.9 | 362 | 475.9 | 541.2 |
| 1994.5 | 156.5 | 194.1 | 301.7 | 390.1 | ND |
| 3089.0 | ND | 152.3 | 229.2 | ND | ND |

The data of Table 2 demonstrate that as the acid comonomers of the ethylene-methacrylic acid ionomer are further neutralized with aluminum cations, the viscosity quickly increases. For example, at a shear rate of 24.3 s⁻¹ and a temperature of 220° C., the increase in viscosity accomplished by neutralizing an additional 18% of the acid comonomer (Example 5) relative to the original ionomer material (Comparative Example 1) is 170%.

Table 3 presents viscosity data obtained from Comparative Example 1 and Example 5 as a function of temperature. The benefit provided by introducing the aluminum component can be seen when comparing the low temperature data (200° C.) to the high temperature data (230° C.) for a given shear rate. In addition to dramatically increasing viscosity, the introduction of the trivalent aluminum provides a material that has a melt viscosity that is less sensitive to temperature changes at lower shear rates. For example, by decreasing temperature from 230° C. to 200° C. at a shear rate of 24.3 s⁻¹, Comparative Example 1 has a change in viscosity of 82% (2501.4/1377.4); however, Example 3 only shows a change of 38% in viscosity between these two temperature extremes (4443.2/3218.8).

TABLE 3
Apparent Viscosity (Pascal seconds) as Function of Shear Rate & Temperature

| Apparent | | | | | | | | |
|---|---|---|---|---|---|---|---|---|
| Shear Rate | Comparative Example 1 | | | | Example 5 | | | |
| (s⁻¹) | 200° C. | 210° C. | 220° C. | 230° C. | 200° C. | 210° C. | 220° C. | 230° C. |
| 316.2 | 718.5 | 694.6 | 398.4 | 404.7 | 1640.1 | 1545.6 | 1249 | 1005.1 |
| 7.3 | 4958.1 | 3401.7 | 3109 | 2518.9 | 6839.3 | 8959.6 | 7429.2 | 5850.9 |
| 12.2 | 3692.3 | 2601.8 | 2478 | 1913.1 | 5988 | 6820.2 | 5366.2 | 4447.9 |
| 24.3 | 2501.4 | 1903.5 | 1492 | 1377.4 | 4443.2 | 5079.3 | 4022.3 | 3218.8 |
| 36.5 | 2005.6 | 1626.1 | 1043 | 1122.3 | 3854.9 | 4071.7 | 3395.7 | 2652.8 |
| 73 | 1446 | 1120.8 | 757.3 | 795.5 | 2957.3 | 3073.7 | 2448.8 | 1948.2 |
| 97.3 | 1274.6 | 968.5 | 666 | 695.9 | 2762 | 2826.6 | 2249.1 | 1772 |
| 145.9 | 1060.2 | 809.9 | 562 | 576.3 | 2530.1 | 2349.9 | 1878 | 1465.1 |
| 316.2 | 734.3 | 555.9 | 396.2 | 413.9 | 1793.2 | 1573.1 | 1307.5 | 1016.5 |
| 681 | 481.7 | 369.1 | 274.7 | 297 | 1202.3 | 1010.9 | 867.2 | 685.6 |
| 1447.2 | 303 | 215.7 | 184.6 | 193.2 | 686.6 | 642.2 | 541.2 | 433.5 |
| 1994.5 | 247.5 | 179.2 | 156.5 | 164.9 | 493 | 495.6 | ND | 362 |
| 3089 | 185.1 | ND | ND | ND | ND | ND | ND | 255.7 |

Table 4 presents melt tension and flexural modulus data obtained for Comparative Examples 1 and 2 and Example 5. The flexural moduli of the materials were measured according to ASTM D790 on ⅛-inch thick bars that were die-cut from solid plaques formed by compression molding, at 200° C., the pellets produced in the BUSS-KNEADER operation.

The melt tension data were obtained using a GOFFERT RHEOTENS in connection with the KAYENESS GALAXY 5 CAPILLARY RHEOMETER described above. For melt tension testing, the materials were also dried for 18 hours at 50° C. They were then tested for melt strength by extruding a melt strand of the polymer at 220° C. through the 30 L/D capillary die. The strand was extruded through the die using a constant head speed on the capillary rheometer of 6.35 mm/min while the take-up speed of the RHEOTENS equipment was varied from 0 to 120 cm/s.

Average melt tension (a measure of melt strength) data were recorded as the maximum force required to break the molten polymer strand. The maximum draw ratio of the strand was also recorded at this failure point defined as the ratio of the take-up speed to the strand extrusion speed.

TABLE 4
Flexural Modulus, Melt Tension, and Melt Draw Properties

| | Comp. | Comp. | |
|---|---|---|---|
| | Example 1 | Example 2 | Example 5 |
| Flexural Modulus at | 4000 | 38000 | 5000 |
| 23° C. (ASTM D790) | | | |
| (psi) | | | |
| Average Melt Tension | 10.3 | 13.5 | 125.3 |
| of melt at 220° C. (cN) | | | |
| Maximum Draw of | 162.3 | 83.7 | 22.8 |
| melt at 220° C. (%) | | | |

In addition to increasing viscosity, the incorporation of aluminum cations greatly increases the melt tension of the molten material. The data in Table 4 show that the material of Example 5 has over 10 times the melt strength of the material of the control, Comparative Example 1 (125.3 cN versus 10.3 cN). Furthermore, the increase in viscosity and melt strength provided by incorporating the aluminum cations into the material has only a limited effect on room temperature flexural modulus. This provides for a polymeric material that has the improved melt properties, important for manufacturing extrudable foams, while maintaining a high degree of softness and flexibility. Comparative Example 2 shows that while a slight increase in melt strength can be accomplished by removing the acrylate comonomer, increasing the methacrylic acid level, and introducing additional Zn⁺² cations, this increase comes at the expense of a dramatic increase in flex modulus. Comparative Example 2 has a 31% increase in melt strength relative to Comparative Example 1 (13.5 versus 10.3 cN), but the material also is nearly 10 times as stiff (38,000 psi flex modulus versus 4,000 psi).

The foregoing disclosure of embodiments of the present invention has been presented for purposes of illustration and description. It is not intended to be exhaustive or to limit the invention to the precise forms described. Many variations and modifications of the embodiments described herein will be obvious to one of ordinary skill in the art in light of the disclosure.

What is claimed is:

1. An ionomer composition comprising at least one direct or graft copolymer of ethylene, α,β-ethylenically unsaturated carboxylic acid having from 3 to 8 carbon atoms, and softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms; wherein the unsaturated carboxylic acid content is from about 1 to about 25 weight percent, the softening comonomer content is from 0 to about 60 weight percent; the remainder being ethylene, such that the ethylene content is greater than about 30 weight percent; further wherein about 3 to about 50% of the acid groups derived from the α,β-ethylenically unsaturated carboxylic acid are neutralized with trivalent cations and a finite amount up to about 70% of the acid groups are neutralized with mono- or divalent cations.

2. The ionomer composition of claim 1 wherein the melt strength and melt viscosity are higher than those of a composition comprising an ionomer containing the same copolymer but neutralized only with mono- or divalent cations and the sensitivity of melt viscosity to temperature at a shear rate of less than about 100 s⁻¹ is lower than those of a composition comprising an ionomer containing the same copolymer but neutralized only with mono- or divalent cations.

3. The ionomer composition of claim 1 having a flex modulus of less than about 15,000 psi.

4. A foamed composition having a density of from about 10 to about 200 kg/m³ and comprising the ionomer composition of claim 1.

5. The foamed composition of claim 4 wherein at least 50% of the foam cells are open cells.

6. A foamed composition having a density of from about 10 to about 200 kg/m³ and comprising at least one direct or graft copolymer of ethylene, α,β-ethylenically unsaturated carboxylic acid having from 3 to 8 carbon atoms, and softening comonomer selected from the group consisting of vinyl esters of aliphatic carboxylic acids wherein the acids have from 2 to 10 carbon atoms, alkyl vinyl ethers wherein the alkyl group contains from 1 to 10 carbon atoms, and alkyl acrylates or methacrylates wherein the alkyl group contains from 1 to 10 carbon atoms; wherein the unsaturated carboxylic acid content is from about 1 to about 25 weight percent, the softening comonomer content is from 0 to about 60 weight percent; the remainder being ethylene, such that the ethylene content is greater than about 30 weight percent; further wherein about 3 to about 50% of the acid groups derived from the α,β-ethylenically unsaturated carboxylic acid are neutralized with trivalent cations and from 0 to about 70% of the acid groups are neutralized with mono- or divalent cations.

7. The foamed composition of claim 6 wherein at least 50% of the foam cells are open cells.

8. A polymer blend comprising the ionomer composition of claim 1 and at least one thermoplastic polymer selected from the group consisting of polyethylene, polypropylene and copolymers thereof, polybutene-1, poly(4-methylpentene-1), polystyrene and copolymers thereof.

9. The polymer blend of claim 8 comprising polyethylene.

10. The polymer blend of claim 9 comprising linear, low-density polyethylene.

11. The polymer blend of claim 8 further comprising at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber.

12. A foamed composition having a density of from about 10 to about 200 kg/m³ and comprising the polymer blend of claim 8.

13. The polymer blend of claim 12 wherein at least 50% of the foam cells are open cells.

14. A multilayer structure comprising at least one layer of the foamed composition of claim 6 in contact with at least one layer of a superabsorbent polymer.

15. The multilayer structure of claim 14 wherein at least 50% of the foam cells are open cells.

16. The multilayer structure of claim 14 wherein the foamed composition further comprises at least one thermoplastic polymer selected from the group consisting of polyethylene, polypropylene and copolymers thereof, polybutene-1, poly(4-methylpentene-1), polystyrene and copolymers thereof.

17. The multilayer structure of claim 16 wherein the foamed composition further comprises at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber.

18. An article comprising the multilayer structure of claim 14.

19. The article of claim 18 that is selected from the group consisting of diapers, adult incontinence pads and sanitary napkins.

20. An article comprising the ionomer composition of claim 1.

21. The article of claim 20 wherein the ionomer composition further comprises at least one thermoplastic polymer selected from the group consisting of polyethylene, polypropylene and copolymers thereof, polybutene-1, poly(4-methylpentene-1), polystyrene and copolymers thereof.

22. The article of claim 21 wherein the ionomer composition further comprises at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber.

23. The article of claim 20 wherein the ionomer composition is in the form of a foamed composition having a density of from about 10 to about 200 kg/m³.

24. The article of claim 23 wherein at least 50% of the foam cells are open cells.

25. The article of claim 20 comprising a multilayer structure comprising at least one layer of the ionomer composition that is in the form of a foamed composition having a density of from about 10 to about 200 kg/m³ in contact with at least one layer of superabsorbent polymer.

26. The article of claim 25 wherein the ionomer composition further comprises at least one thermoplastic polymer selected from the group consisting of polyethylene, polypropylene and copolymers thereof, polybutene-1, poly(4-methylpentene-1), polystyrene and copolymers thereof.

27. The article of claim 26 wherein the ionomer composition further comprises at least one elastomer selected from the group consisting of styrene-isoprene block copolymer, styrene-butadiene block copolymer, styrene-ethylene-butadiene block copolymer, ethylene-propylene rubber and ethylene-propylene-diene monomer rubber.

28. The article of claim 20 that is selected from the group consisting of diapers, adult incontinence pads and sanitary napkins.

29. A process for preparing a melt processible blend of an ionomer composition and a thermoplastic resin or an elastomer comprising the steps of
(A) mixing at from about 1500 to about 300° C.
a. from about 15 to about 100% by weight of direct or graft copolymer of ethylene, an alpha,beta-ethylenically unsaturated carboxylic acid having from 3 to 8 carbon atoms, and a softening comonomer selected from the group consisting of vinyl esters of aliphatic carboxylic acids wherein the acids have 2 to 10 carbon atoms, vinyl ethers wherein the alkyl group contains 1 to 10 carbon atoms, and alkyl acrylates or methacrylates, wherein the alkyl group contains 1 to 10 carbon atoms, and wherein the ethylene content of the copolymer is greater than about 30 weight percent, the carboxylic acid content is from about 1 to about 25 weight percent and the softening comonomer content is from 0 to about 60 weight percent and
b. a finite amount up to about 85% by weight of at least one thermoplastic resin or thermoplastic elastomer selected from the group consisting of polyamide, polyester, polyester ether, block copolymer of aromatic substituted ethylenically unsaturated monomer with diolefin and hydrogenated derivative of said copolymer, polyurethane, and polyolefin resin which thermoplastic resin or thermoplastic elastomer is nonreactive with the aluminum ion source, and
(B) subsequent to or simultaneously with said mixing, neutralizing from about 3 to about 50% of the carboxylic acid groups with a trivalent ion source and neutralizing a finite amount up to about 70% of the acid groups with a monovalent or divalent ion source.

30. The process of claim 29, wherein the trivalent ion is an aluminum ion.

31. The process of claim 29, further comprising the step of foaming the melt processible blend.

32. A product obtainable from the process of claim 29.
